(19) United States
(12) Patent Application Publication
(10) Pub. No.: US 2020/0407239 A1
(43) Pub. Date: Dec. 31, 2020

(54) FILTER AND FILTER MEDIA FOR REMOVING ORGANIC ACID FROM WATER

(71) Applicant: Aqua Guidance Technologies, Ltd., Nassau (BS)

(72) Inventors: Andrew Lombardo, Pompano Beach, FL (US); Symon Thomas, Brundall (GB)

(21) Appl. No.: 16/915,125

(22) Filed: Jun. 29, 2020

Related U.S. Application Data
(60) Provisional application No. 62/868,883, filed on Jun. 29, 2019.

(51) Int. Cl. C02F 1/28; B01D 39/20

(52) U.S. Cl. CPC C02F 1/28; B01D 2239/04; C02F 2305/00; B01D 39/2058

(57) ABSTRACT

Disclosed is a filter media for removing contaminants such as organic acids from water. The filter media comprises porous particles. The particles have a total pore volume greater than about 0.4 cc/g. The pore volume is primarily or substantially comprised of epipores, that is, pores that are larger than about 5 nm. The filter media may also include a non-porous filter material and a binder. The filter media may be formed into a filter element, with the binder joining particles of the filter media together into a solid body. The percentage of the total pore volume provided by epipores is greater than about 40%. The filter reduces an initial concentration of an organic acid by greater than 80% at a flux greater than 0.76 ml/min/cm².

This application claims priority under 35 U.S.C. § 119 to U.S. Provisional Patent Application No. 62/868,883, filed on Jun. 29, 2019. The disclosure of that application is incorporated herein by reference.

### BACKGROUND

### Field

The present invention relates to filters and media for filters for removing substances from water. In particular, the present invention relates to a filter media including porous media particles with high macropore and mesopore volumes that removes organic acids from water.

### Description of the Related Art

Many people rely on water supplies drawn from surface water bodies such as lakes, rivers, and streams. These sources often include water that has been in contact with soil organic material. This organic material includes dead matter such as leaves, animal waste, and other decaying material. This material is sometimes referred to as humus. When water flows through humus, it may dissolve various substances that enter the water supply including organic acids, such as fulvic, humic, and tannic acids. Organic acids may enter water supplies as a result of contact with material in landfills. In some cases, organic acids constitute 90% of the total organic carbon found in leachate from landfills.

Organic acids are undesirable in drinking water. They may introduce unpalatable taste, noxious odor, and unsightly color to the water. While organic acids themselves are generally not harmful to humans, the taste, odor and color can cause consumers to believe that the water is unsafe. In addition, humic acids can react with other chemical, including chlorine ions to create toxic substances such as dihaloacetonitriles and chlorinated carbon molecules. Organic acids may also alter the pH of water supplies and cause other issues within a water system.

In addition, organic acids can have detrimental effects for water filtration systems. For example, water is sometimes purified using a reverse osmosis (RO) system. Such a system relies on a semi-permeable membrane separating water to be filtered on one side, and a flow of wastewater on the other. A pressure differential is established between the two sides of the membrane such that water to be purified passes through the membrane and contaminants are excluded by the membrane and removed by the flow of wastewater. Organic acids, which may have a wide range of molecular weights, include fractions that are larger than the pores of the semipermeable membrane. These organic acids may collect on the surface of the membrane, reducing the capacity of the RO system and necessitating cleaning and/or replacement of the membrane.

Organic acid contamination in drinking water sources is of particular concern in less developed regions of the world. Residents in poorer countries typically rely on water from local streams and lakes that are subject to may sources of pollution, including human and animal waste. In these regions, infrastructure to treat sewage, as well as industrial waste or even distribute treated water, may be lacking. Moreover, agriculture is often the main source of income for local residents. Run-off from agricultural fields and animal feed lots contribute organic acids to the surface water used for drinking.

One way to improve the efficiency of water filters is to use a pressure driven system. Adding a mechanism to pressurize water to be filtered may add complexity and cost to the filter and may decrease its reliability. In addition, in less developed regions the infrastructure to provide a pressurized water source, for example, by municipal piping connected with an elevated water tank or reservoir, may be impractical. Likewise, adding a pump to a system may add cost and complexity, particularly in regions that lack electrical service. Simpler, gravity-fed or low-pressure systems would be preferable. However, known filter systems that rely on gravity may not be effective in removing organic acids.

### SUMMARY

The present disclosure relates to apparatuses and methods to address these difficulties.

The present disclosure provides a filter media for improved removal of organic acids using mesoporous and/or macroporous filter media. The media may contain porous filter particles where a significant portion of the total pore volume is provided by mesopores and macropores, and where a smaller portion of the total pore volume is contributed by micropores. A surprising result of using filter materials with a significant portion of their total pore volume contributed by pores larger than about 5 nm is that they effectively remove organic acids, such as humic acid, from water. As used herein, pores larger than about 5 nm, which comprise mesopores and some macropores are referred to as “epipores.” Embodiments of the disclosure include porous filter media where a substantial portion of the total pore volume is contributed by epipores.

According to one embodiment of the present disclosure, filters were formed using a combination of a smaller particle size material with a larger particle size material, where both materials are porous. Before being formed into a filter media, the combined materials were determined to have a specific total pore volume measured by ATSM method D 6556:2017-11 utilizing BJH interpolation preferably between about 0.4 cc/g and about 3.0 cc/g, more preferably from about 0.8 cc/g to about 1.8 cc/g, and most preferably between about 1.2 cc/g and 1.6 cc/g. According to a preferred embodiment, greater than about 40% of the total pore volume is contributed by epipores, more preferably greater than about 50% contributed by epipores, and still more preferably greater than about 60% contributed by epipores. According to a most preferred embodiment, greater than about 65% of the total pore volume is contributed by epipores.

According to another aspect, the disclosure provides a filter media that reduces the concentration of organic acids in water. According to a preferred embodiment, the filter media reduces organic acid concentration to below about 1.0 ppm from an initial concentration of preferably between about 100 ppm to 2 ppm, more preferably from about 20 ppm to 5 ppm, and most preferably from about 10 ppm to 6 ppm in the raw input water. According to a further aspect, the filter media removes organic acids at a flow rate preferably greater than about 10 ml/min, more preferably greater than about 30 ml/min, and most preferably greater than about 70 ml/min. According to another embodiment, the filter media removes organic acids at a flow rate per area, i.e., a flux, of greater than 0.22 ml/min/cm², more preferably greater than 0.65 ml/min/cm², and most preferably greater than 1.54 ml/min/cm².

According to a further aspect, the filter media provides this reduction in organic acid concentration over a lifetime of preferably more than about 1 day, more preferably more than about 4 days, and most preferably more than about 4.5 days.

According to one embodiment of the disclosure there is provided a filter comprising a filter housing and a filter media. The filter media comprises porous filter particles, a non-porous filter material, and a non-thermoplastic adhesive. The total pore volume of the filter media is greater than about 0.25 cc/g and the percentage of the total pore volume provided by epipores is between about 35% to about 90%. The filter reduces an initial concentration of an organic acid by greater than 80%. The organic acid may be humic acid, fulvic acid, or tannic acid and combinations thereof. The initial concentration of the organic acid may be between 100 ppm and 10 ppm. The porous filter particles may comprise lignite. The lignite particles may be activated by heating in a reducing atmosphere.

The filter media may be formed into an immobile mass using a binder. The binder may a thermoset polymer, for example, Ultra High Molecular Weight Polyethylene.

According to a further embodiment the filter media as a total pore volume of between 0.25 cc/g and 1.2 cc/g and the pore volume provided by micropores is less than about 0.1 cc/g. According to a still further embodiment the porous particles have a total pore volume of between 0.25 cc/g and 0.7 cc/g.

The non-porous filter material and/or the non-thermoplastic adhesive may comprise a cationic compound. The cationic compound may comprise one or more of polyvinylamine, poly(N-methylvinylamine), polyallylamine, polyallyldimethylamine, polydiallylmethylamine, polyvinylpyridinium chloride, poly (2-vinylpyridine), poly(4-vinylpyridine), polyvinylimidazole, poly(4-aminomethylstyrene), poly(4-aminostyrene), polyvinyl(acrylamide-co-dimethylaminopropylacrylamide), polyvinyl(acrylamide-co-dimethylaminoethylmethacrylate), polyethyleneimine, polylysine, poly diallyl dimethyl ammonium chloride (pDADMAC), poly(propylene)imine dendrimer (DAB-Am) and Poly(amidoamine) (PAMAM) dendrimers, polyaminoamides, polyhexamethylenebiguandide, polydimethylamine-epichlorohydrine, aminopropyltriethoxysilane, N-(2-aminoethyl)-3-aminopropyltrimethoxysilane, N-trimethoxysilylpropyl-N,N,N-trimethylammonium chloride, bis(trimethoxysilylpropyl)amine, chitosan, Poly-(D)glucosamine, grafted starch, the product of alkylation of polyethyleneimine by methylchloride, the product of alkylation of polyaminoamides with epichlorohydrine, cationic polyacrylamide with cationic monomers, dimethyl aminoethyl acrylate methylchloride (AETAC), dimethyl aminoethyl methacrylate methyl chloride (METAC), acrylamidopropyl trimethyl ammonium chloride (APTAC), methacrylamidopropyl trimethyl ammonium chloride (MAPTAC), diallyl dimethyl ammonium chloride (DADMAC), ionenes, silanes, benzalkonium chloride, benzethonium chloride, methylbenzethonium chloride, cetalkonium chloride, cetylpyridinium chloride, cetrimonium, cetrimide, dofanium chloride, tetraethylammonium bromide, didecyldimethylammonium chloride and domiphen bromide, and combinations thereof.

According to another embodiment, the filter media is formed into a molded or extruded porous block. This may be done by placing combining the filter media with a thermoplastic binder, placing the mixture in a mold and subjecting it to an elevated temperature to shape the media into the puck. The elevated temperature may be sufficient to melt the binder.

According to some embodiments, there is disclosed a filter element comprising: a filter media having a total pore volume and comprising porous filter particles; a non-porous filter material; and a binder, wherein the total pore volume is greater than about 0.4 cc/g and where the percentage of the total pore volume provided by epipores is above about 40%, and wherein, when subject to an influent flux greater than about 0.7 ml/min/cm² the filter element reduces an initial concentration of an organic acid in water by greater than 80%. The filter media may have a total pore volume of between 0.4 cc/g and 1.2 cc/g and the pore volume provided by micropores may be less than about 0.1 cc/g. The filter element may have a total pore volume of about 0.5 cc/g.

The non-porous filter material may comprise a cationic compound. The cationic compound may comprise one or more of polyvinylamine, poly(N-methylvinylamine), polyallylamine, polyallyldimethylamine, polydiallylmethylamine, polyvinylpyridinium chloride, poly (2-vinylpyridine), poly(4-vinylpyridine), polyvinylimidazole, poly(4-aminomethylstyrene), poly(4-aminostyrene), polyvinyl(acrylamide-co-dimethylaminopropylacrylamide), polyvinyl(acrylamide-co-dimethylaminoethylmethacrylate), polyethyleneimine, polylysine, poly diallyl dimethyl ammonium chloride (pDADMAC), poly(propylene)imine dendrimer (DAB-Am) and Poly(amidoamine) (PAMAM) dendrimers, polyaminoamides, polyhexamethylenebiguandide, polydimethylamine-epichlorohydrine, aminopropyltriethoxysilane, N-(2-aminoethyl)-3-aminopropyltrimethoxysilane, N-trimethoxysilylpropyl-N,N,N-trimethylammonium chloride, bis(trimethoxysilylpropyl)amine, chitosan, Poly-(D)glucosamine, grafted starch, the product of alkylation of polyethyleneimine by methylchloride, the product of alkylation of polyaminoamides with epichlorohydrine, cationic polyacrylamide with cationic monomers, dimethyl aminoethyl acrylate methylchloride (AETAC), dimethyl aminoethyl methacrylate methyl chloride (METAC), acrylamidopropyl trimethyl ammonium chloride (APTAC), methacrylamidopropyl trimethyl ammonium chloride (MAPTAC), diallyl dimethyl ammonium chloride (DADMAC), ionenes, silanes, benzalkonium chloride, benzethonium chloride, methylbenzethonium chloride, cetalkonium chloride, cetylpyridinium chloride, cetrimonium, cetrimide, dofanium chloride, tetraethylammonium bromide, didecyldimethylammonium chloride and domiphen bromide, and combinations thereof.

The filter media may be molded to form a solid body. According to one aspect the filter media is placed in a mold and subject to an elevated temperature to shape the media into the solid body. The elevated temperature may be sufficient to melt the binder.

The organic acid may be selected from one or more of humic acid, fulvic acid, or tannic acid and combinations thereof. The initial concentration of organic acid may be between 100 ppm and 10 ppm.

The porous filter particles may comprise about 20% by weight of small particle lignite and about 80% by weight of large particle lignite. The large particle lignite comprises particles may be sieved to a size of 40×80. The lignite particles may be activated by heating in a reducing atmosphere.

The binder may be a thermoset polymer. The thermoset polymer may comprise Ultra High Molecular Weight Polyethylene.

When the influent flux is greater than about 1.4 ml/min/cm², the filter element may reduce an initial concentration of the organic acid by greater than 90%.

According to another aspect, there is disclosed a filter housing comprising a filter element comprising: a filter media having a total pore volume and comprising porous filter particles; a non-porous filter material; and a binder, wherein the total pore volume is greater than about 0.4 cc/g and where the percentage of the total pore volume provided by epipores is above about 40%, and wherein, when subject to an influent flux greater than about 0.7 ml/min/cm² the filter element reduces an initial concentration of an organic acid in water by greater than 80%.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram of an apparatus used to test filter elements according to embodiments of the disclosure;

FIG. 2 is a graph comparing the concentration of humic acid present in effluent filtered by a filter element according to an embodiment of the disclosure compared with another filter element using the test apparatus illustrated in FIG. 1 when the elements were subjected to an initial humic acid concentration of 10 ppm;

FIG. 3 is a graph comparing the concentration of humic acid present in effluent filtered by a filter element according to a further embodiment of the disclosure compared with another filter element using the test apparatus illustrated in FIG. 1, when the elements were subjected to an initial humic acid concentration of 10 ppm; and

FIG. 4 is a graph comparing the concentration of humic acid present in effluent filtered by a filter element according to a still further embodiment of the disclosure compared with another filter element using the test apparatus illustrated in FIG. 1, when the elements were subjected to an initial humic acid concentration of 10 ppm.

### DETAILED DESCRIPTION

The present disclosure provides embodiments of a filter and of filter media that unexpectedly removes significant fractions of organic acid from water by providing pore volumes that are primarily or substantially contributed by epipores. Such a filter has particular application to treat water supplies with elevated levels of organic acids, such as humic, fulvic, and tannic acids. Moreover, filters made from media according to the present disclosure may remove organic acids with relatively little pressure differential, allowing them to function in gravity fed systems.

Organic acids are found in water that flows through soils that contain humic substances (i.e, decaying organic matter). Organic acids such as humic acid may comprise macromolecules of a wide range of molecular weights and/or macromolecular complexes where different molecular constituents are bound with one another by relatively weak van der Waals forces, by π-π stacking between aromatic rings and other non-covalent bonding. Not to be bound by theory, but it is believed that mesopores and macropores provide regions that are sized to accommodate large molecules and molecular complexes formed by organic acids. For example, one investigator reports that humic acid molecules in solution likely have an irregular, elongated shape and a hydrodynamic radius of about 2 to 3 nm, a radius of gyration of about 7 to 10 nm, and a maximum diameter of about 20-30 nm. M. Kawahigashi et al., Particle Sizes of Standard Humic Substances Calculated as Radii of Gyration, Maximum Diameter and Hydrodynamic Radii, Humic Substances Research Vol. 8 (2011), pp. 13-18. Filter media with a significant portion of its pore volume provided by macropores and mesopores according to the present disclosure may provide an improved ability to adsorb organic acids because the majority of pore volume is provide by pores large enough to admit humic acid molecules, that is, epipores with a pore diameters of about 5 nm or greater.

According to one embodiment, a filter media according to the disclosure includes porous media particles alone or in combination with non-porous components. Porous media particles may be formed from carbon compounds such as but not limited to lignite, anthracite, or bituminous coal, peat, oil, tar, carbonized organic matter such as wood, bamboo, coconut husk, or bone, from zeolite particles such as, but not limited to, analcime, leucite, pollucite, wairakite, clinoptilolite, barrerite, chabazite, phillipsite, amicite, or gobbinsite, from a calcium compound such as monocalcium phosphate, dicalcium phosphate, monetite, brushite, tricalcium phosphate, whitlockite, octacalcium phosphate, dicalcium diphosphate, calcium triphosphate, hydroxyapatite, apatite, tetracalcium phosphate, diatomaceous earth, expanded glass or ceramic particles, pumice, and the like. Non-porous components may be beads, fibers or flakes of glass or a polymer, silica sand, alumina, bauxite, magnesia, titanium dioxide, clay, ceramic particles or fibers, polymer particles or fibers, and the like. The non-porous components may also comprise non-thermoplastic adhesive compounds.

Non-porous components may also include materials that provide ionized surfaces to attract and sequester charged particles. These materials may be polymers that form a cationic surface and can include polyvinylamine, poly(N-methylvinylamine), polyallylamine, polyallyldimethylamine, polydiallylmethylamine, polyvinylpyridinium chloride, poly (2-vinylpyridine), poly(4-vinylpyridine), polyvinylimidazole, poly(4-aminomethylstyrene), poly(4-aminostyrene), polyvinyl(acrylamide-co-dimethylaminopropylacrylamide), polyvinyl(acrylamide-co-dimethylaminoethylmethacrylate), polyethyleneimine, polylysine, poly diallyl dimethyl ammonium chloride (pDADMAC), poly(propylene)imine dendrimer (DAB-Am) and Poly(amidoamine) (PAMAM) dendrimers, polyaminoamides, polyhexamethylenebiguandide, polydimethylamine-epichlorohydrine, aminopropyltriethoxysilane, N-(2-aminoethyl)-3-aminopropyltrimethoxysilane, N-trimethoxysilylpropyl-N,N,N-trimethylammonium chloride, bis(trimethoxysilylpropyl)amine, chitosan, Poly-(D)glucosamine, grafted starch, the product of alkylation of polyethyleneimine by methylchloride, the product of alkylation of polyaminoamides with epichlorohydrine, cationic polyacrylamide with cationic monomers, dimethyl aminoethyl acrylate methylchloride (AETAC), dimethyl aminoethyl methacrylate methyl chloride (METAC), acrylamidopropyl trimethyl ammonium chloride (APTAC), methacrylamidopropyl trimethyl ammonium chloride (MAPTAC), diallyl dimethyl ammonium chloride (DADMAC), ionenes, silanes and combinations of these compounds. Non-porous materials may also include quaternary ammonium compounds such as benzalkonium chloride, benzethonium chloride, methylbenzethonium chloride, cetalkonium chloride, cetylpyridinium chloride, cetrimonium, cetrimide, dofanium chloride, tetraethylammonium bromide, didecyldimethylammonium chloride and domiphen bromide, and combinations of these compounds. The porous filter media as well as non-porous components are selected so that, when formed into a filter element, the media and components form voids and support pathways for the flow of water through and around the particles. According to one embodiment, the filter material may include other components and/or be processed to enhance the flow of effluent through the filter element. Such components and processes are disclosed in co-pending U.S. Provisional Patent Appl. No. 62/868,885, filed Jun. 29, 2019 and U.S. patent application Ser. No. ______, filed ______ (Attny Docket No. 250-0004US), which are incorporated herein by reference.

As persons of skill in the art will understand, mesopores are pores with a diameter from about 2 nanometers to about 50 nanometers. Macropores are understood to be pores with a diameter greater than about 50 nm. Pores with a diameter less than about 2 nm are considered to be micropores. As discussed above, embodiments of the present disclosure exhibit a surprising ability to sequester organic acids, such as humic acids, which have molecular sizes in the range of mesopores and macropores. For simplicity of disclosure, pores greater than about 5 nm, which include macropores and some mesopores will be referred to herein as epipores. A surprising result of using filter media formed according to the present disclosure is that, by selecting a distribution of pore volumes so that the majority or a substantial portion of pore volume is provided by epipores, is that such media can reduce the concentration of organic acids in water significantly compared with filter media that is microporous.

Porous filter media according to one embodiment of the disclosure, has a specific total pore volume preferably between about 0.4 cc/g and about 3.0 cc/g, more preferably from about 0.8 cc/g to about 1.8 cc/g, and most preferably between about 1.2 cc/g and 1.6 cc/g. According to a preferred embodiment, greater than about 40% of the pore volume is contributed by epipores, more preferably greater than about 50% contributed by epipores, and still more preferably greater than about 60% contributed by epipores. According to a most preferred embodiment, greater than about 65% of the total pore volume is contributed by epipores.

Pore volume provided by pores of various sizes was measured using the Brunauer-Emmett-Teller (BET) technique and applying the Barrett-Joyner-Halenda (BJH) determination in a manner known to those of ordinary skill in the field of materials analysis. This technique uses a gas at its boiling point that condenses on the material, including on the inner surfaces of the pores, and measures the volume of the gas that condenses as a function of the ratio of the pressure of the gas to its saturation pressure, P/Po.

Samples of the filter media and components used to form the media were tested using nitrogen gas at its boiling point, 77 K. The gas was applied at a range of pressures and the volume of condensed gas was monitored as a function of P/Po. The value P/Po determines the pore size range in which the gas will condense with gas condensing in smaller pores at lower pressure due to the interaction of gas molecules with walls of the pores. The amount of gas condensed on the sample indicates the pore volume. P/Po below about 0.58 measures pore volume for micropores with a size less than about 5 nm. P/Po above about 0.58 measures the volume of epipores, with a pore size above about 5 nm. According to one embodiment, pore volume is measured using BET performed according to ASTM D6556.

According to one embodiment, the filter material is provided as a loose bed. The bed of material may be contained in a housing having an inlet and an outlet with a mesh across the outlet to hold the material in the housing while water flows through the bed of material. According to another embodiment, the filter material is immobilized into a solid body in the form of a puck, block, cylinder, or the like. One such filter is described in co-pending U.S. patent application Ser. No. 16/176,398, filed Oct. 31, 2018, which is incorporated herein by reference.

Particles forming the filter may be immobilized by providing a binder to the mixture of particles. The binder joins adjacent particles to one another to form a solid filter. The binder may be a thermoplastic polymer such as polyethylene, polycarbonate, polyvinylchloride, polyamideimide, polyethersulphone, polyetherimide, polyarylate, polysulphone, polyamide, polymethylmethacrylate, acrylonitrile butadiene styrene, polystyrene, polyetheretherketone, polytetrafluoroethylene, polyamide 6,6, polyamide 11, polyphenylene sulphide, polyethylene terephthalate, polyoxymethylene, polypropylene, polydimethyl siloxane, polyoxymethylene, polyethylene terephthalate, polyetheretherketone, nylon 6, polysulphone, polyphenylene sulphide, polyethersulphone, and the like. According to a preferred embodiment, the binder is Ultra High Molecular Weight Polyethylene (UHMWPE).

To form a puck, the binder is added to a mixture of porous filter media particles according to an embodiment of the disclosure. The mixture is placed in a mold and subject to a temperature of about 180° C., sufficient to melt and liquify the polymer. Pressure may be applied to the mold to force the material to conform to the mold cavity to shape the filter material into a suitable configuration. When the material cools the polymer hardens, joining the particles into a solid, immobile puck. The puck is then assembled in a housing that provides a path for raw, untreated water to flow through the filter material. According to another embodiment, instead of shaping the material in a mold cavity, the filter material is heated to liquefy the polymer and is forced through an extrusion die to form an extruded body. The extruded body is then cut to a length suitable to form a filter element.

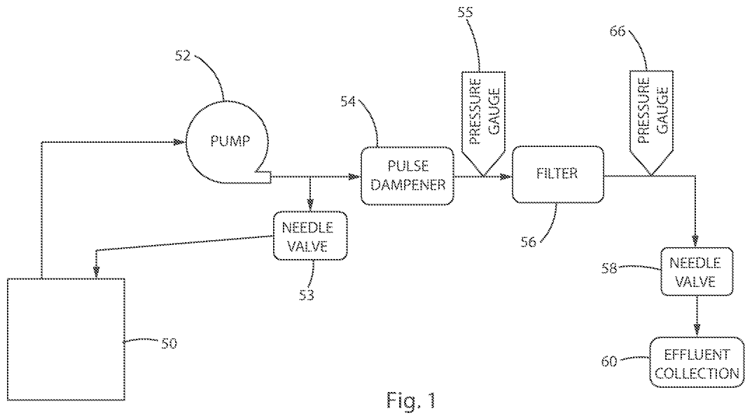

FIG. 1 shows a schematic of a testing apparatus used to determine the ability of filters according to embodiments of the disclosure to remove contaminants, such as organic acids, from water. A raw water reservoir 50 was connected with a diaphragm pump 52. A pulse dampener 54 was connected with the output of pump 52. A needle valve 53 was provided to divert some of the flow of water back to reservoir 50. A filter 56, including a filter element made according to other examples of the disclosure was connected with the output of pulse dampener 54. Pressure gauges 55 and 66 were provided at the inlet and outlet of filter 56. An outlet needle valve 58 was connected with the outlet of filter 56. Outlet needle valve 58 drained into effluent container 60.

In operation, the pump was energized and needle valves 53 and 58 were adjusted to provide a desired flow rate through the filter. Pressure drop across the filter was monitored by gauges 55 and 66. The reservoir 50 was charged with a humic acid solution prepared by combining humic acid (SKU No. H16752 from Sigma-Aldrich) with reverse-osmosis, deionized (RO/DI) water at a concentration identified in the Examples below.

### Example 1

A filter media was prepared using a mixture of larger particle size lignite carbon and smaller particle size lignite carbon with pore volumes primarily or substantially provided by epipores. In this example, the larger particle size carbon was Lignite 3000 manufactured by Cabot Norit Americas, Inc. and the smaller particle size carbon was Lignite M, also manufactured by Cabot Norit. In this example, about 80% by weight of large particle lignite material was combined with about 20% small particle lignite material to form the filter material mixture. This material was combined with a binder and molded to form a filter element.

The large particle size and small particle size carbon materials and the 80:20 mixture were analyzed to determine the contribution of pore volumes by pores of various sizes using BET. The results are presented in Table 1 below:

TABLE 1

| | Macropore/ | | Total | Epipore | |
|---|---|---|---|---|---|
| | Mesopore | Micropore | Pore | Volume | |
| | volume | Volume | Volume | (>5 nm) | % Epipore |
| | (cc/g) | (cc/g) | (cc/g) | (cc/g) | volume |
| Larger | 0.452 | 0.114 | 0.566 | 0.261 | 46 |
| particle size | | | | | |
| Smaller | 0.395 | 0.050 | 0.445 | 0.276 | 62 |
| particle size | | | | | |
| 80:20 mixture | 0.410 | 0.135 | 0.545 | 0.221 | 41 |

A filter sample was prepared by mixing about 67% by weight of Lignite 3000 (large particle) with about 17% by weight of lignite M (small particle) and about 17% of a binder, Ultra High Molecular Weight Polyethylene (Product No. GUR-2122 manufactured by Celanese) (“UHMWPE”). This material was well mixed. The material was analyzed using BET to determine the total pore volume and the percentage of pore volume contributed by epipores. The material had a total pore volume of 0.545 g/cc with about 41% of that volume contributed by epipores.

About 82 grams of the mixture was placed in a 3-inch diameter aluminum mold and compressed to a thickness of about 1 inch. The mixture in the mold was subjected to a temperature of 180° C. for about 3.5 hours, causing the binder to bind the carbon particles into a cylindrical filter element with a surface area of 45.60 cm² across the face of the cylinder, a volume of 115.8 cm³, and a density of 0.71 g/cc.

### Example 2

A filter media was prepared using a mixture of larger particle size coconut shell carbon and smaller particle size coconut shell carbon with pore volumes primarily provided by micropores in the same ratio as in Example 1, that is, 80% by weight large particle material and 20% by weight small particle material. In this example, the larger particle size carbon was 40×80 mesh coconut shell carbon and the smaller particle size material was −325 mesh coconut shell carbon, both supplied by EnviroSupply and Service of Irvine, Calif. The carbon materials were analyzed to determine the contribution of pore volumes by pores of various sizes using BET in the same manner as discussed for Example 1. Notably, a significant portion of the pore volume for this coconut carbon mixture is provided by micropores. This is different from the pore volumes for the material used to form the filter in Example 1, where pore volume was provided predominantly or substantially by epipores. The pore volume results for the filter material in Example 2 are presented in Table 2 below:

TABLE 2

| | Macropore/ | | Total | Epipore | |
|---|---|---|---|---|---|
| | Mesopore | Micropore | Pore | Volume | |
| | volume | Volume | Volume | (>5 nm) | % Epipore |
| | (cc/g) | (cc/g) | (cc/g) | (cc/g) | volume |
| Larger | 0.109 | 0.104 | 0.213 | 0.034 | 16.0 |
| particle size | | | | | |
| Smaller | 0.112 | 0.147 | 0.259 | 0.034 | 13.1 |
| particle size | | | | | |

A filter sample was prepared by mixing about 67% by weight of was 40×80 mesh coconut shell carbon (large particle) with about 17% by weight of −325 mesh coconut shell carbon (small particle) and about 17% of the UHMWPE. This material was well mixed. About 84 grams of the mixture was placed in a 3-inch diameter aluminum mold and compressed to a thickness of about 1 inch. The mixture in the mold was subjected to a temperature of 180° C. for about 3.5 hours, causing the binder to bind the carbon particles into a cylindrical filter element with a surface area of 45.6 cm² across the face of the cylinder, a volume of 115.8 cm³, and a density of 0.73 g/cm³.

### Example 3

The filters produced in Examples 1 and 2 were put in the test stand described with respect to FIG. 1, above. Reservoir 50 was filled with a 10 ppm solution of humic acid to form an influent. Outlet needle valve 58 was closed and return needle valve 53 was adjusted so that 60 PSI of pressure was applied to the input of filter 56 as measured by gauge 55 when no influent water was flowing through the filter. Outlet needle valve 58 was adjusted so that the flow rate through filter 56 was approximately 35 ml/min. According to this embodiment, such a flow rate allows the solution flowing through the filter to have a contact time with the filter element of approximately 198 seconds. According to one embodiment, the flow rate of 35 ml/min through filter 56 with the dimensions in Examples 1 and 2 with a surface area of 45.6 cm² expressed in terms of flux, that is, flow rate per unit area is about 0.77 ml/min/cm². Samples of effluent were collected periodically and tested for humic acid concentration.

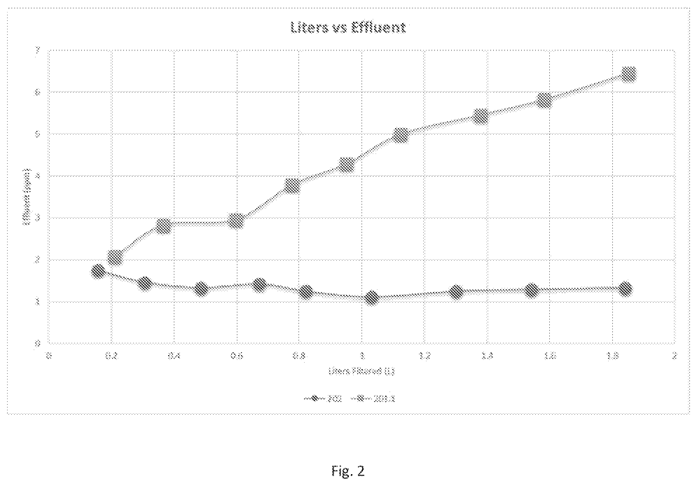

FIG. 2 compares the concentration of humic acid in the effluent collected periodically for each filter of Examples 1 and 2 as a function of the volume of effluent filtered. The results for the filter made in Example 1 comprised of particles with a relatively large portion of epipores are identified as “202” in the graph of FIG. 2. The concentration of humic acid was reduced from about 10 ppm to less than about 1.5 ppm. This represents about an 85% reduction in humic acid concentration. This humic acid reduction continued throughout the experiment until about 2 liters of effluent had been filtered.

The results for filter element formed in Example 2 are identified as “201.1” in FIG. 2. This filter element comprised a relatively small portion of pore volume contributed by epipores. This filter element initially reduced humic acid concentration to about 2 ppm, or about 80% at the beginning of the experiment. As effluent passed through the filter made according to Example 2, however, the amount of humic acid that passed through the filter rapidly increased indicating a significant drop in the ability of a filter element to remove organic acid from water. As shown in FIG. 2, when about 2 liters of solution passed through the filter of Example 2, samples of the effluent show that only about 30% of the initial humic acid was removed and that almost 7 ppm of humic acid was present in the effluent.

### Example 4

To better characterize particle size, a filter similar to the one described in Example 1 was prepared, but instead of using the Lignite 3000 as received, the Lignite 3000 material was ground and sieved to 40×80. The same 80:20 ratio of large particle Lignite 3000 to smaller particle Lignite M was mixed with the binder (i.e., 17% by weight lignite M and 67% by weight ground and sieved Lignite 3000 and 17% UHMWPE binder). About 82 grams of the mixture was placed in a 3″ OD×1″ high mold and formed into a cylindrical element in the manner described in Example 1.

### Example 5

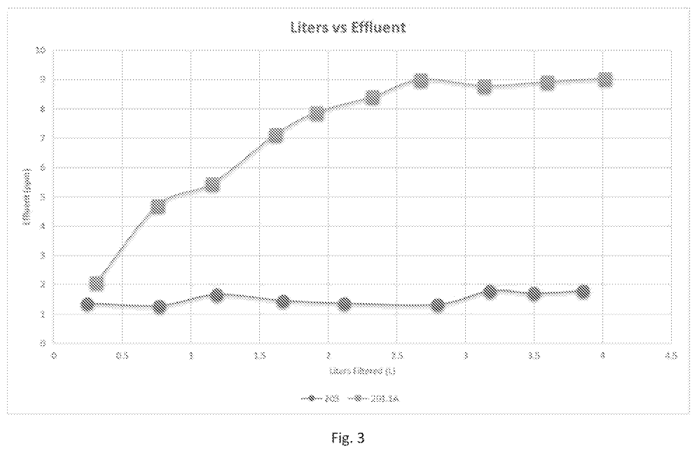

The filter element created in Example 4 was tested in the test stand shown in FIG. 1 using a 10 ppm solution of humic acid and compared with another filter element created as described in Example 2. For each of these filter elements, outlet valve 58 was adjusted so that the flow rate was about 70 ml per min, about twice the flow rate of Example 3. FIG. 3 shows the concentration of humic acid in the effluent as a function of the volume of effluent filtered. The filter element formed in Example 4, identified as “203” in FIG. 3, performed substantially better in removing humic acid than the filter element from Example 2, identified as “201.1A” in FIG. 3. At a flow rate of 70 ml/min, the flux through the filter element is 1.56 ml/min/cm².

As shown in FIG. 3, the filter element of Example 4 reduced humic acid concentration to less than about 2 ppm and did so steadily throughout the experiment until about 4 liters of water had been filtered. By contrast, the filter element of Example 2 initially reduced humic acid to about 2 ppm, but the concentration of humic acid increased until, at about 4 liters of effluent filtered, the concentration of humic acid was about 9 ppm for the sample collected, showing that the filter element formed with material with a substantial portion of its pore volume provided by pores less than about 5 nm, was only able to reduce the concentration of humic acid by about 10% after 4 liters of water had been filtered.

### Example 6

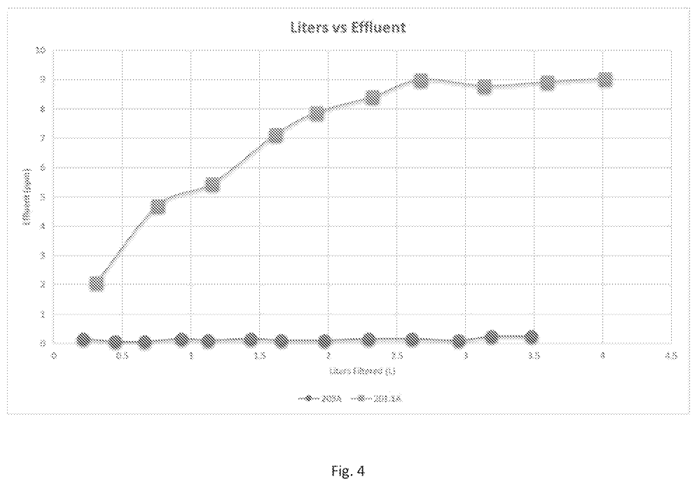

The filter element described in Example 4, with pore volume provided substantially or primarily by epipores and with the particles sizes of the larger carbon particles sieved to 40×80 was compared with the element of Example 2, with pore volume contributed by smaller pores, at a reduced flow rate. Again, the test stand of FIG. 1 was used with the reservoir filled with a 10 ppm humic acid solution. In this case, the flow rate was adjusted to 35 ml/min. FIG. 4 shows a comparison of the element according to Example 4, identified as “203A” with a filter element according to Example 2 identified as “201.1A.” Here, humic acid was reduced by the filter element of Example 4 to less than about 0.3 ppm throughout the experiment, that is, by about 97%. By comparison, the element of Example 2 initially reduced humic acid concentration to about 2 ppm as shown in the examples above. But this filter element quickly lost the ability to remove the organic acid, only reducing humic acid concentration to about 9 ppm (or by only about 10%) when about 4 liters of effluent had been filtered.

While illustrative embodiments of the disclosure have been described and illustrated above, it should be understood that these are exemplary of the disclosure and are not to be considered as limiting. Additions, deletions, substitutions, and other modifications can be made without departing from the spirit or scope of the disclosure. Accordingly, the disclosure is not to be considered as limited by the foregoing description.

We claim:

1. A filter element comprising:
a filter media having a total pore volume and comprising
porous filter particles;
a non-porous filter material; and
a binder,
wherein the total pore volume is greater than about 0.4 cc/g and where the percentage of the total pore volume provided by epipores is above about 40%, and
wherein, when subject to an influent flux greater than about 0.7 ml/min/cm² the filter element reduces an initial concentration of an organic acid in water by greater than 80%.

2. The filter element according to claim 1, wherein the filter media has a total pore volume of between 0.4 cc/g and 1.2 cc/g and wherein the pore volume provided by micropores is less than about 0.1 cc/g.

3. The filter element of claim 2, wherein the filter media has a total pore volume of about 0.5 cc/g.

4. The filter element of claim 1, wherein the non-porous filter material comprises a cationic compound.

5. The filter element of claim 4, wherein the cationic compound comprises one or more of polyvinylamine, poly(N-methylvinylamine), polyallylamine, polyallyldimethylamine, polydiallylmethylamine, polyvinylpyridinium chloride, poly (2-vinylpyridine), poly(4-vinylpyridine), polyvinylimidazole, poly(4-aminomethylstyrene), poly(4-aminostyrene), polyvinyl(acrylamide-co-dimethylaminopropylacrylamide), polyvinyl(acrylamide-co-dimethylaminoethylmethacrylate), polyethyleneimine, polylysine, poly diallyl dimethyl ammonium chloride (pDADMAC), poly(propylene)imine dendrimer (DAB-Am) and Poly(amidoamine) (PAMAM) dendrimers, polyaminoamides, polyhexamethylenebiguandide, polydimethylamine-epichlorohydrine, aminopropyltriethoxysilane, N-(2-aminoethyl)-3-aminopropyltrimethoxysilane, N-trimethoxysilylpropyl-N,N,N-trimethylammonium chloride, bis(trimethoxysilylpropyl)amine, chitosan, Poly-(D)glucosamine, grafted starch, the product of alkylation of polyethyleneimine by methylchloride, the product of alkylation of polyaminoamides with epichlorohydrine, cationic polyacrylamide with cationic monomers, dimethyl aminoethyl acrylate methylchloride (AETAC), dimethyl aminoethyl methacrylate methyl chloride (METAC), acrylamidopropyl trimethyl ammonium chloride (APTAC), methacrylamidopropyl trimethyl ammonium chloride (MAPTAC), diallyl dimethyl ammonium chloride (DADMAC), ionenes, silanes, benzalkonium chloride, benzethonium chloride, methylbenzethonium chloride, cetalkonium chloride, cetylpyridinium chloride, cetrimonium, cetrimide, dofanium chloride, tetraethylammonium bromide, didecyldimethylammonium chloride and domiphen bromide, and combinations thereof.

6. The filter element of claim 1, wherein the filter media is molded to form a solid body.

7. The filter element of claim 6, wherein the filter media is placed in a mold and subject to an elevated temperature to shape the media into the solid body.

8. The filter element of claim 7, wherein the elevated temperature is sufficient to melt the binder.

9. The filter element of claim 1, wherein the organic acid is selected from one or more of humic acid, fulvic acid, or tannic acid and combinations thereof.

10. The filter element of claim 1, wherein the initial concentration of organic acid is between 100 ppm and 10 ppm.

11. The filter element of claim 1, wherein the porous filter particles comprise about 20% by weight of small particle lignite and about 80% by weight of large particle lignite.

12. The filter element of claim 1, wherein the large particle lignite comprises particles sieved to a size of 40×80.

13. The filter element of claim 11, wherein the lignite particles are activated by heating in a reducing atmosphere.

14. The filter element of claim 1, wherein the binder is a thermoset polymer.

15. The filter element of claim 14, wherein the thermoset polymer comprises Ultra High Molecular Weight Polyethylene.

16. The filter element of claim 12, wherein, when the influent flux is greater than about 1.4 ml/min/cm², the filter element reduces an initial concentration of the organic acid by greater than 90%.

17. The filter element of claim 1, further comprising a filter housing.
